(19) United States
(12) Patent Application Publication
(10) Pub. No.: US 2007/0230356 A1
(43) Pub. Date: Oct. 4, 2007

(54) Method and apparatus for enabling FLO device certification

(76) Inventors: Sacchindrakumar Gopikisan Kalantri, San Diego, CA (US); Jake Levi, San Diego, CA (US)

Correspondence Address: QUALCOMM INCORPORATED, 5775 MOREHOUSE DR., SAN DIEGO, CA, 92121, US

(21) Appl. No.: 11/398,075

(22) Filed: Apr. 4, 2006

(51) Int. Cl. H04L 12/26; H04J 3/16

(52) U.S. Cl. 370/241; 370/466

(57) ABSTRACT

Systems and methodologies are described that facilitate certifying Forward Link Only (FLO) mobile devices. According to various aspects, systems and/or methods are described that facilitate simulating a FLO network to enable device qualification, certification, testing, measuring, etc. Such systems and/or methods may employ a captured asynchronous serial interface (ASI) stream that may be utilized to recreate FLO network conditions existing at a time of data capture.

### BACKGROUND

I. Field

The following description relates generally to wireless communications, and more particularly to simulating a Forward Link Only (FLO) network to enable certification of a FLO user device in a wireless communication system.

II. Background

Wireless communication systems are widely deployed to provide various types of communication; for instance, voice and/or data may be provided via such wireless communication systems. A typical wireless communication system, or network, can provide multiple users access to one or more shared resources. For instance, a system may use a variety of multiple access techniques such as Frequency Division Multiplexing (FDM), Time Division Multiplexing (TDM), Code Division. Multiplexing (CDM), and others.

Common wireless communication systems employ one or more base: stations that provide a coverage area. A typical base station can transmit multiple data streams for broadcast, multicast and/or unicast services, wherein a data stream may be a stream of data that can be of independent reception interest to a user device. A user device within the coverage area of such base station can be employed to receive one, more than one, or all the data streams carried by the composite stream. Likewise, a user device can transmit data to the base station or another user device.

Recently, broadcast techniques such as Forward Link Only (FLO) technology have been developed and employed to provide content (e.g., video, audio, multimedia, IP datacast, . . . ) to portable user device(s). FLO technology can be designed to achieve high quality reception, both for real-time content streaming and other data services. FLO technology can provide robust mobile performance and high capacity without compromising power consumption. In addition, FLO technology may reduce costs associated with delivering multimedia content by decreasing the number of deployed base station transmitters. Furthermore, FLO technology based multimedia multicasting can be complimentary to wireless operators' cellular network data and voice services, delivering content to the same mobile devices. FLO may employ orthogonal frequency division multiplexing (OFDM) based multicast technology without a reverse link or with a limited reverse link.

FLO techniques have recently become utilized with greater frequency; however, common techniques for certifying FLO user device(s) may be difficult at best to implement. Conventionally, OEMs, carriers, handset certification agencies, etc. may effectuate independent verification of FLO user device(s) by employing a FLO network. However, setup, learning and/or managing of such FLO network may be expensive and time-consuming.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with certifying Forward Link Only (FLO) mobile devices. According to various aspects, systems and/or methods are described that facilitate simulating a FLO network to enable device qualification, certification, testing, measuring, etc. Such systems and/or methods may employ a captured asynchronous serial interface (ASI) stream that may be utilized to recreate FLO network conditions existing at a time of data capture.

According to related aspects, a method that facilitates simulating a Forward Link Only (FLO) network for enabling device certification is described herein. The method may comprise capturing an asynchronous serial interface (ASI) stream generated for a FLO transmission. Moreover, the method may include retaining the ASI stream for simulating the FLO transmission.

Another aspect relates to a wireless communications apparatus may include a memory that may retain a captured asynchronous serial interface (ASI) stream. Further, a processor may evaluate the ASI stream to identify time information, synchronize at least one of a CDMA network and an exciter based upon the time information, and transmit the ASI stream to the exciter to simulate a Forward Link Only (FLO) network

Yet another aspect relates to a wireless communications apparatus that simulates a Forward Link Only (FLO) network for utilization in connection with certifying FLO enabled devices. The wireless communications apparatus may include means for generating an asynchronous serial interface (ASI) stream for a FLO transmission; means for capturing the ASI stream; means for retaining the ASI stream; and/or means for simulating the FLO transmission utilizing the retained ASI stream.

Still another aspect relates to a machine-readable medium having stored thereon machine-executable instructions that may be for requesting initialization information from a CDMA network, initializing a Forward Link Only (FLO) device being tested based upon the initialization information, receiving a FLO waveform obtained from a time-shifted asynchronous serial interface (ASI) stream that simulates a FLO network, and/or communicating via the CDMA network.

In accordance with another aspect, a processor is described herein, wherein the processor may execute instructions for capturing an asynchronous serial interface (ASI) stream and storing the ASI stream. Further, the processor may execute instructions for transmitting the ASI stream to an exciter for generating a radio frequency signal that simulates a Forward Link Only (FLO) transmission for testing a FLO enabled device.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of a system that simulates a FLO network to enable mobile device testing and/or certification.

FIG. 3 is an illustration of a system that intercepts and/or retains ASI stream(s) for utilization in connection with simulating a FLO network.

FIG. 4 is an illustration of a wireless communications system intercepts and/or stores data in a compact manner for utilization in connection with simulating a FLO network for mobile device compliance testing.

FIG. 5 is an illustration of a system that enables certification of a FLO user device.

FIG. 6 is an illustration of an exemplary timing diagram associated with certifying a FLO mobile device.

FIG. 7 is an illustration of a methodology that facilitates intercepting and/or storing ASI stream(s) that may be utilized to simulate a FLO network.

FIG. 8 is an illustration of a methodology that facilitates simulating a FLO network to enable testing FLO enabled mobile device(s).

FIG. 9 is an illustration of a methodology that facilitates testing a FLO user device and/or performing signaling over a CDMA network.

FIG. 10 is an illustration of a wireless network environment that can be employed in conjunction with the various systems and methods described herein.

FIG. 11 is an illustration of a communication network that comprises an embodiment of a transport system that operates to create and transport multimedia content flows across data networks.

FIG. 12 is an illustration of a content provider server suitable for use in an embodiment of a content delivery system.

FIG. 13 is an illustration of a content server (CS) or device suitable for use in one or more embodiments of a content delivery system.

FIG. 14 is an illustration of a system that simulates a FLO network for utilization in connection with certifying FLO enabled devices.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a subscriber station. A subscriber station can also be called a system, a subscriber unit, mobile station, mobile, remote station, access point, remote terminal, access terminal, user terminal, user agent, a user device, or user equipment. A subscriber station may be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

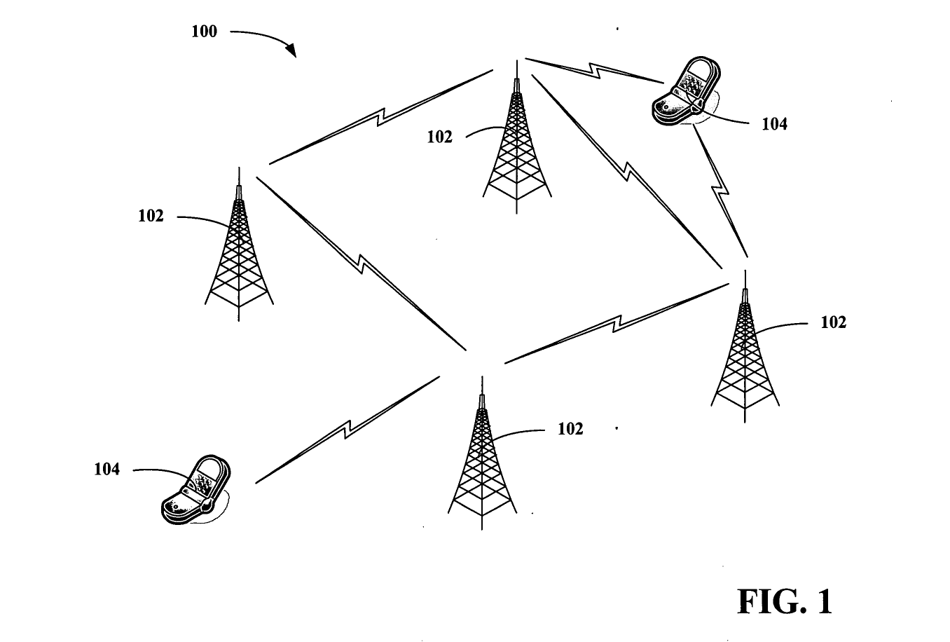

Referring now to FIG. 1, a wireless communication system 100 is illustrated in accordance with various embodiments presented herein. System 100 can comprise one or more base stations 102 (e.g., access points) in one or more sectors that receive, transmit, repeat, etc., wireless communication signals to each other and/or to one or more mobile devices 104. Each base station 102 can comprise a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art. Mobile devices 104 can be, for example, cellular phones, smart phones, laptops, handheld communication devices, handheld computing devices, satellite radios, global positioning systems, PDAs, and/or any other suitable device for communicating over wireless communication system 100.

Base stations 102 can broadcast content to mobile devices 104 by employing Forward Link Only (FLO) technology. For instance, real time audio and/or video signals may be broadcast, as well as non-real time services (e.g., music, weather, news summaries, traffic, financial information, . . . ). According to an example, content may be broadcast by base stations 102 to mobile devices 104. Mobile devices 104 may receive and output such content (e.g., by employing visual output(s), audio output(s), . . . ). Moreover, FLO technology may utilize orthogonal frequency division multiplexing (OFDM). Frequency division based techniques such as OFDM typically separate the frequency spectrum into distinct channels; for instance, the frequency spectrum may be split into uniform chunks of bandwidth. OFDM effectively partitions the overall system bandwidth into multiple orthogonal frequency channels. Additionally, an OFDM system may use time and/or frequency division multiplexing to achieve orthogonality among multiple data transmissions for multiple base stations 102.

Conventionally, mobile devices 104 may be certified for compliance with FLO techniques by testing such mobile devices 104 within a full FLO network. Initializing and/or utilizing such FLO network for testing purposes may be time-consuming, resource intensive, and/or expensive. Thus, system 100 may employ a FLO network simulator (not shown) to simulate FLO network operation. Further, one skilled in the art would appreciate that network operation associated with Digital Video Broadcasting—Handheld (DVB-H), Digital Multimedia Broadcasting (DMB), and so forth may similarly be simulated. The FLO network simulator may be employed for certification, qualification, etc. of mobile devices 104. Accordingly, OEMs, carriers, handset certification agencies, etc. may perform independent verification of mobile devices 104 for utilization with FLO techniques by employing the FLO network simulator.

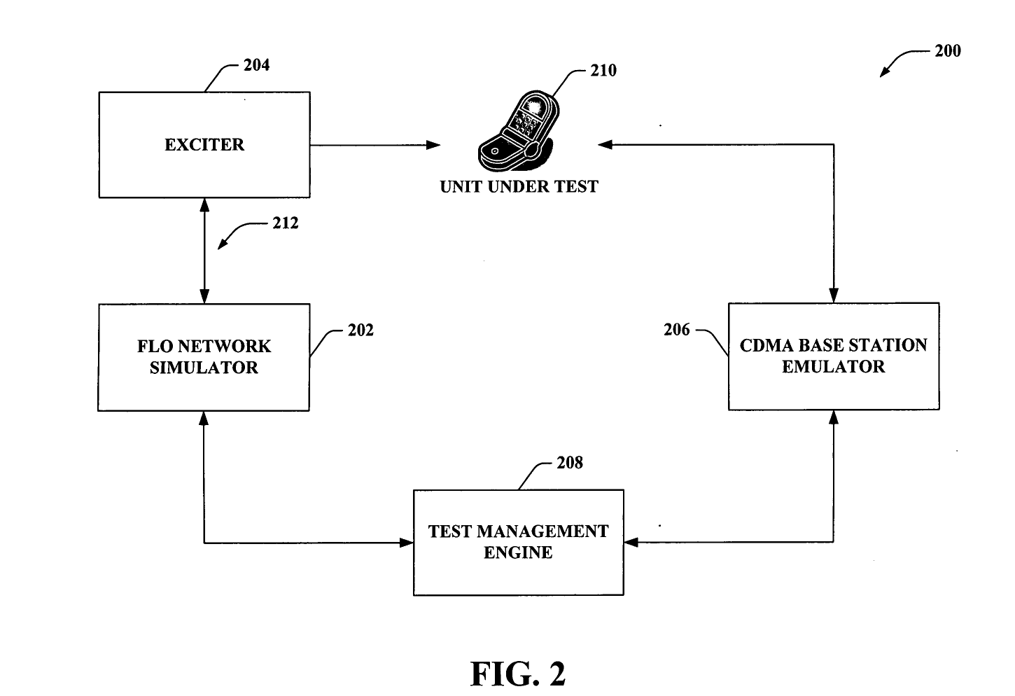

With reference to FIG. 2, illustrated is a system 200 that simulates a FLO network to enable mobile device testing and/or certification. System 200 may include a FLO network simulator 202 that generates data and signaling information representative of a real FLO network. The data may be communicated to an exciter 204 that may convert the data into radio frequency for transmission over the air. Further, system 200 may include a code division multiple access (CDMA) base station emulator 206, a test management engine 208 that coordinates system 200, and/or a unit under test (UUT) 210 (e.g., mobile device, FLO user device, . . . ). Thus, FLO network simulator 202 may provide data to UUT 210 by way of exciter 204 and/or may exchange signaling information (and/or disparate data) with UUT 210 via CDMA base station emulator 206.

FLO network simulator 202 may generate an asynchronous serial interface (ASI) stream that may be understood by exciter 204. The ASI stream may be similar to an ASI stream communicated to FLO transmitters for real FLO networks. According to an illustration, the ASI stream generated in a real FLO network may be captured and retained; thereafter, FLO network simulator 202 may retrieve and output the ASI stream at a disparate time to allow for simulating the real FLO network. FLO network simulator 202 may simulate disparate layers of a stack such as a service layer, an application layer, etc. and therefore allow for executing tests pertaining to service level, application level, etc. device qualification. As opposed to conventional techniques that may simulate a physical layer only, FLO network simulator 202 enables simulating, for instance, activation, digital rights management conditional access service (CAS) (e.g., key delivery, key expiration, decryption of secure data, . . . ), subscriptions (e.g., selecting service retailer, auto subscribe packages, subscription information retrieval, add/cancel subscriptions, . . . ), provisioning, signaling, overhead, programming guides, channel data (e.g., real time audio/video, real time audio, clipcasting, data services via clipcasting, IP datacast data, barker presentations, . . . ), content ratings, notifications, and so forth.

FLO network simulator 202 may communicate ASI stream(s) to exciter 204 via an ASI interface 212. Exciter 204 may employ the ASI stream(s) to yield a FLO waveform that may be provided to UUT 210. It is to be appreciated that the FLO waveform may include, for instance, audio data, video data, clipcast data, Internet Protocol Datacasting (IPDC) data, any disparate data sent over FLO stream(s), programming guide (e.g., FLO programming guide), system information, time information (e.g., FLO time), and so forth.

FLO network simulator 202 may include (and/or may obtain from a related data store) canned data and signaling information representative of a real FLO network. Further, FLO network simulator 202 may generate an ASI stream that may be understood by exciter 204. The notion of time for FLO network simulator 202 may be fixed to a point in time when the canned data was generated. By way of illustration, FLO network simulator 202 may enable synchronizing CDMA base station emulator 206, exciter 204, etc. to such fixed point in time (e.g., based upon timing information encapsulated in the ASI stream(s)); however, the claimed subject matter is not so limited. Moreover, FLO network simulator 202 may provide for relevant activation and/or subscription functionality (e.g., over CDMA base station emulator 206). Pursuant to an example, FLO network simulator 202 enables mitigating timing and/or synchronization issues conventionally associated with employing a real FLO network to test FLO user device(s) (e.g., UUT 210); according to this example, FLO network simulator 202 may facilitate testing UUT 210 by utilizing (e.g., time shifting and playing back) captured ASI stream(s) (e.g., control streams, overhead streams, video streams, audio streams, other data streams, . . . ).

In comparison to ASI stream(s), real FLO waveforms may be difficult to capture and save for later playback due to issues such as quality of signal and amount of disk space associated with storage of FLO waveforms. Accordingly, FLO network simulator 202 may employ ASI stream(s), which may be captured with more accuracy and consume less disk space as compared to FLO waveforms. Further, the ASI stream(s) may include most of the information included in the FLO waveform except for information inserted by exciter 204. Thus, the ASI stream(s) may be played back through exciter 204 to recreate network conditions associated with the original stream. Pursuant to an example, exciter 204 may utilize settings employed by an exciter associated with the real FLO network from which the ASI stream was captured.

The ASI stream(s) utilized by FLO network simulator 202 enable the real FLO network to be represented by encompassing relevant information in a correct format. For instance, the captured stream may be in a digital domain; thus, loss and/or degradation of the signal may be mitigated. Also, by lacking padding, the ASI data may be more compact as compared to digital in-phase and quadrature (I/Q) data. Further, the ASI stream(s) may be captured and/or stored in real time.

UUT 210 may also communicate with CDMA base station emulator 206. Thus, interaction of UUT 210 with both CDMA base station emulator 206 and FLO network simulator 202 may be evaluated. Additionally or alternatively, signaling may be effectuated via CDMA base station emulator 206. For instance, UUT 210 may communicate with CDMA base station emulator 206 to perform signaling (e.g., over the wire (OTW), . . . ). Pursuant to another illustration, FLO signaling may be effectuated by LUT 210 initiating communication(s) transmitted to FLO network simulator 202 that may be transferred via CDMA base station emulator 206 over IP. For example, CDMA base station emulator 206 may employ any type of 3G CDMA technology (e.g., EV-DO, 1x, . . . ). CDMA base station emulator 206 may also provide IP address and DNS IP address information to UUT 210. Moreover, CDMA base station emulator 206 may enable UUT 210 to derive time information from CDMA time. It is to be appreciated that FLO time and CDMA time should be within an acceptable (e.g., predetermined) range.

Test management engine 208 may enable execution of certification testing. Although not depicted, it is to be appreciated that test management engine 208 may be associated with a test management console, which may be a front end (e.g., web based) to manage test cases and/or results. Test management engine 208 may manage FLO network simulator 202. For example, test management engine 208 may setup appropriate configuration files for use by FLO network simulator 202. Additionally or alternatively, test management engine 208 may start, stop, reset, etc. various parts of FLO network simulator 202. Moreover, test management engine 208 may initiate FLO network simulator 202 to transmit ASI stream(s) relevant to a particular test.

Test management engine 208 may also manage exciter 204. For instance, test management engine 208 may reset exciter 204, query a status of exciter 204, and/or select channel parameters. By way of illustration, test management engine 208 may identify a profile of parameters for exciter 204 to employ.

Moreover, test management engine 208 may manage CDMA base station emulator 206. Test management engine 208 may set/get time (e.g., CDMA time), reset CDMA base station emulator 206, query a status of CDMA base station emulator 206, and so on. Additionally or alternatively, test management engine 208 may set and/or get a Device IP, a NetMask, a DNS IP Address, etc. associated with CDMA base station emulator 206.

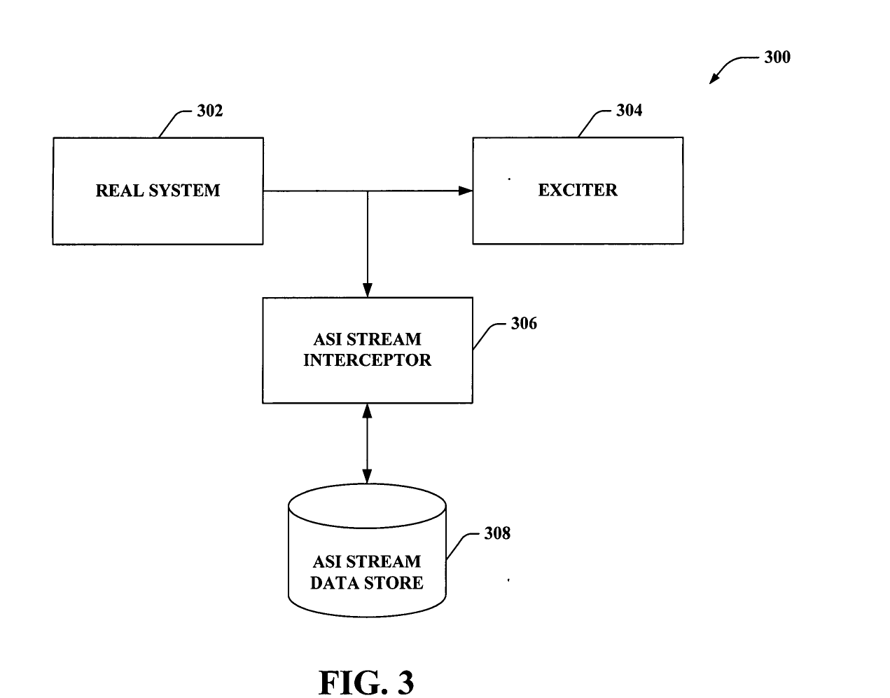

Turning to FIG. 3, illustrated is a system 300 that intercepts and/or retains ASI stream(s) for utilization in connection with simulating a FLO network. System 300 includes a real system 302 that generates ASI stream(s). Real system 302 may transmit the ASI stream(s) via a satellite (not shown) to any number of disparate locations. Each of the disparate locations may be associated with a corresponding exciter such as exciter 304, which may process the ASI stream(s) to generate FLO waveforms for radio frequency transmission to mobile device(s).

System 300 may additionally include an ASI stream interceptor 306 that captures the ASI stream(s) generated by real system 302. For example, ASI stream interceptor 306 may obtain the ASI stream(s) prior to uplink to a satellite. ASI stream interceptor 306 may further communicate with an ASI stream data store 308 to retain the intercepted ASI stream(s). According to an example, ASI stream interceptor 306 may capture the ASI stream(s) in real time and thereafter facilitate storing such information in ASI stream data store 308; however, the claimed subject matter is not so limited. Further, it is contemplated that ASI stream interceptor 306 may be separate from ASI stream data store 308 (as shown), ASI stream interceptor 306 may include ASI stream data store 308 or a portion thereof, and/or ASI stream data store 308 may include ASI stream interceptor 306 or a portion thereof.

It will be appreciated that ASI stream data store 308 described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). ASI stream data store 308 of the subject systems and methods is intended to comprise, without being limited to, these and any other suitable types of memory.

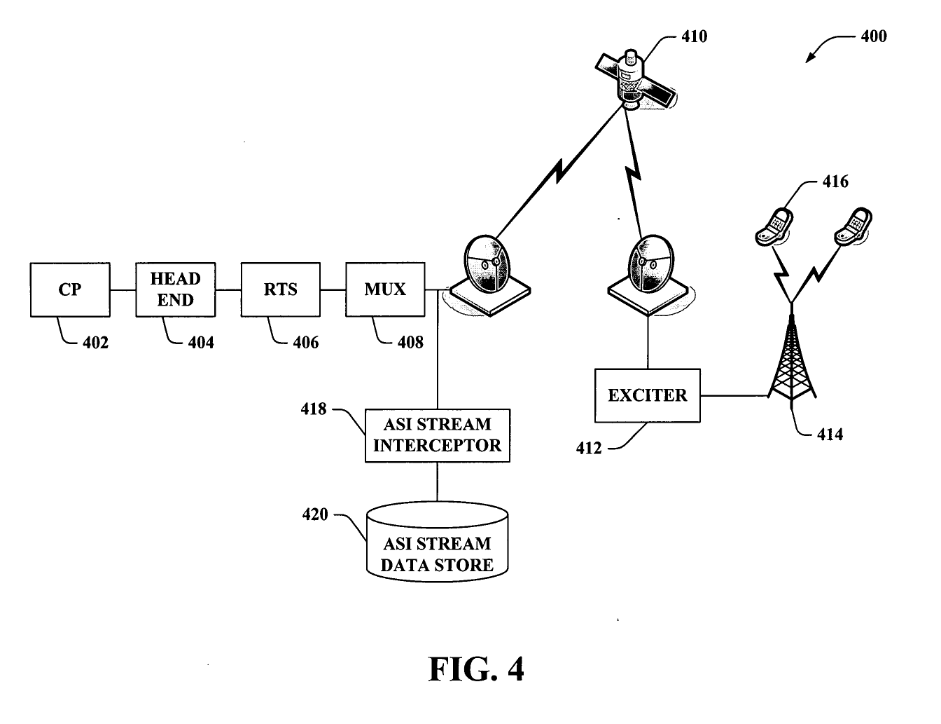

Turning to FIG. 4, illustrated is a wireless communication system 400 that intercepts and/or stores data in a compact manner for utilization in connection with simulating a FLO network for mobile device compliance testing. System 400 depicts an example of an architecture that may be employed in connection with capturing and/or retaining such data. One skilled in the art would recognize that the claimed subject matter is not limited to the example provided in system 400.

System 400 may include a content provider (CP) 402 that provides any type of content to a head end 404. For instance, CP 402 may provide real time and/or non-real time data. Any number of content providers similar to CP 402 and/or any number of head ends similar to head end 404 may be utilized in connection with system 400. Additionally, CP 402 may communicate audio, video, IP datacast, or any disparate type of content to head end 404. Content from any number of sources may be obtained at head end(s) 404 and/or a real time server (RTS) 406. Thereafter, the content may be transferred from RTS 406 to a multiplexer (MUX) 408. Content from disparate sources may be multiplexed by MUX 408. The output yielded by MUX 408 may be ASI stream(s).

The multiplexed data (e.g., ASI stream(s)) may be transmitted to a satellite 410 (e.g., via the Ku band, . . . ) and thereafter communicated to various local area operation infrastructures (LOIs). A LOI may include an exciter 412 that may convert the downlink signal from satellite 410 into radio frequency (e.g., FLO waveform) to enable transmission by base station 414 to any number of mobile devices 416. Base station 414 may utilize FLO technology to broadcast and/or multicast content to one or more mobile devices 416; thus, little or no reverse link transmission from mobile devices 416 to base station 414 may occur. Mobile devices 416 may be mobile and/or located at fixed positions. Further, mobile devices 416 may be utilized intermittently and/or may be associated with limited or no usage diversity. Mobile devices 416 may obtain content from base station 414 and output (e.g., playback, . . . ) such content (e.g., with display(s), speaker(s), . . . ).

System 400 may further include an ASI stream interceptor 418 that obtains ASI stream(s) outputted by MUX 408 prior to uplink over satellite 410. For example, the ASI stream(s) received by ASI stream interceptor 418 may include content such as audio data, video data, clipcast data, IPDC data, programming guide data, system information, FLO time data, and so forth. ASI stream interceptor 418 may provide the ASI stream(s) to an ASI stream data store 420 for storage. Stored ASI stream(s) may be retrieved at a disparate time by a playback subsystem (e.g., FLO network simulator 202 of FIG. 2) in connection with simulating the real FLO network (e.g., transmit subsystem) associated with system 400.

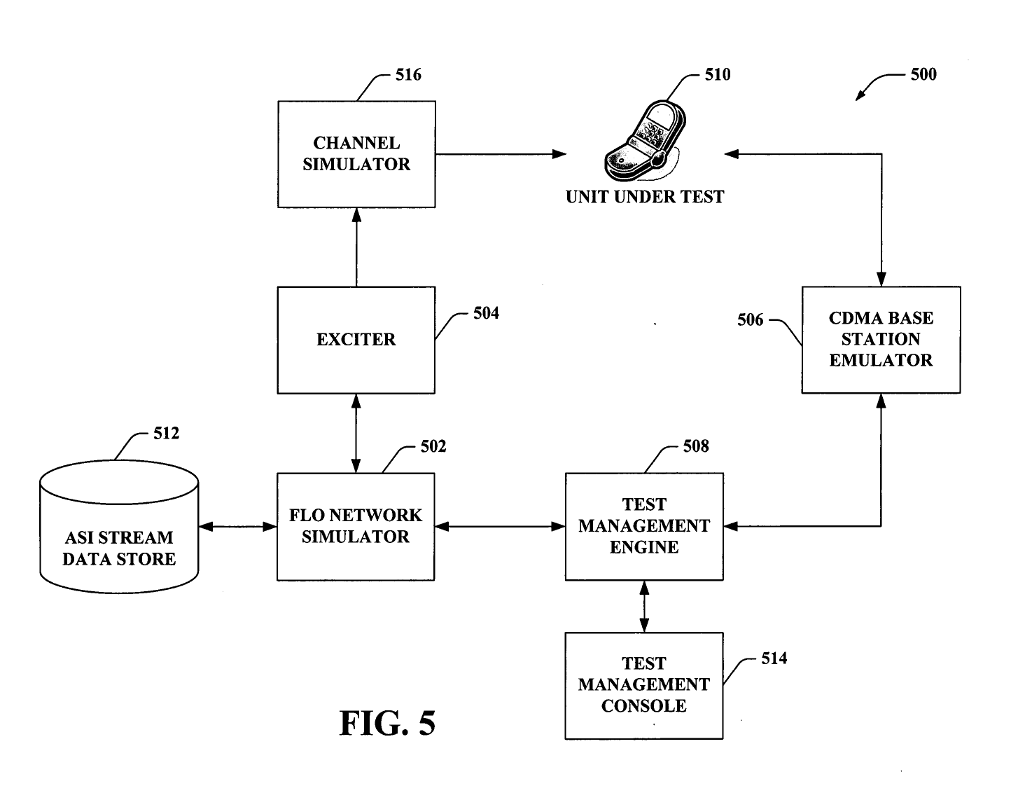

Referring to FIG. 5, illustrated is a system 500 that enables certification of a FLO user device. System 500 may include a FLO network simulator 502, an exciter 504, a CDMA base station emulator 506, a test management engine 508, a unit under test (UUT) 510, and an ASI stream data store 512, each of which may be substantially similar to the respective descriptions above. For example, FLO network simulator 502 may obtain ASI stream(s) and/or disparate data from ASI stream data store 512; thereafter, the ASI stream(s) may be transferred to exciter 504. System 500 may further include a test management console 514 and/or a channel simulator 516.

Test management console 514 may enable user interaction with system 500. For instance, test(s) to perform may be initiated via test management console 514, result(s) of test(s) may be provided to test management console 514, and so forth. Further, feedback concerning operation of system 500 may be provided by way of test management console 514 (e.g., utilizing a visual, audile, etc. output, . . . ). Moreover, test management console 514 may enable automatic execution of selected test(s), management of test sets (e.g., abort, scroll control, . . . ), visibility and management of test queues, observation and management of test status and reports, etc. According to an illustration, test management console 514 may be web based; however, the claimed subject matter is not so limited.

Channel simulator 516 may be utilized to simulate real conditions associated with a transmission channel. By way of example, channel simulator 516 may obtain FLO waveform(s) yielded by exciter 504 and inject noise and/or interference, vary power levels, fade the signal, and the like. Thus, testing of UUT 510 may be accomplished with a simulation of such channel conditions.

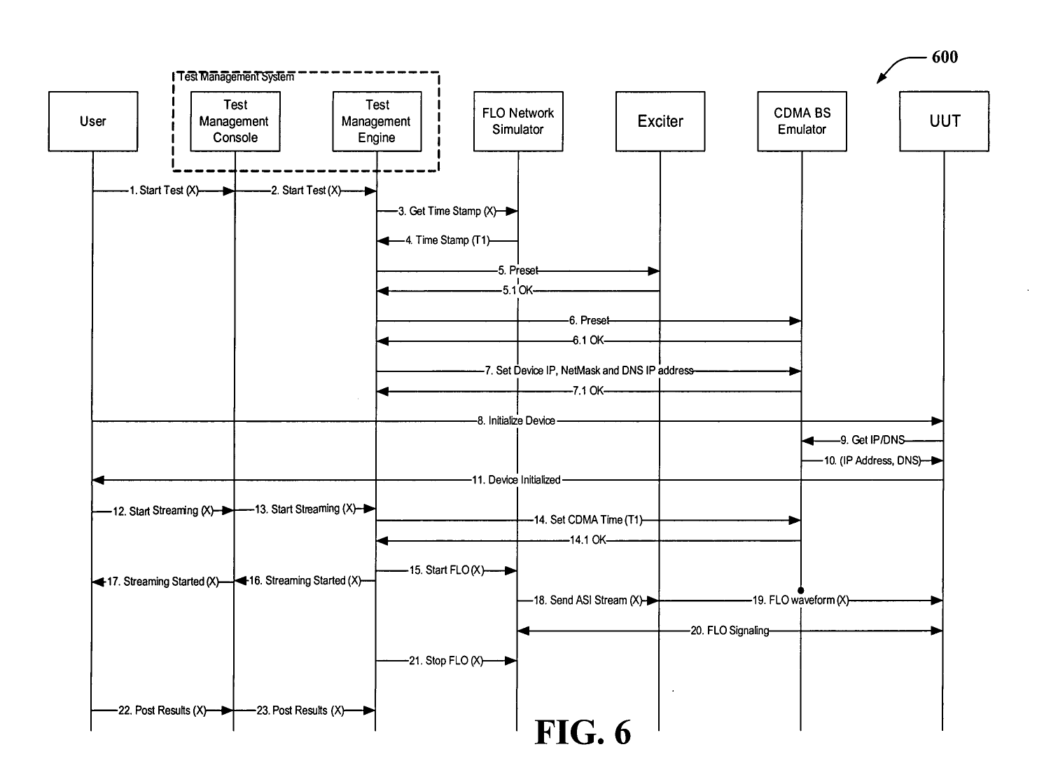

Turning to FIG. 6, illustrated is an exemplary timing diagram 600 associated with certifying a FLO mobile device. It is to be appreciated that timing diagram 600 is presented merely for illustration purposes and the claimed subject matter is not limited to this example. For instance, the order of acts may vary, acts may occur concurrently with disparate acts, additional acts may be included, and/or illustrated acts may be omitted.

At reference numeral 1, a user may issue a command to start a test case X. At 2, a test management console may relay the user's command to start test case X to a test management engine. At 3, the test management engine may request a FLO network simulator to get a timestamp from a stream corresponding to test case X. At 4, the FLO network simulator may return time T1 corresponding to test case X. At 5, the test management engine may transmit a preset request to an exciter and/or identify a profile of parameters to which the exciter should be preset. The exciter may respond (e.g., at 5.1) by transmitting a signal (e.g., OK) after the specified profile was successfully preset. Additionally or alternatively, the test management engine may simulate an OK response by querying the state of the exciter until a READY state is returned. At 6, the test management engine may send a preset request to a CDMA base station emulator and identify a profile of parameters to which the CDMA base station emulator may be set. At 6.1, the CDMA base station emulator may send a response (e.g., OK) after successfully presetting to the specified profile. Additionally or alternatively, the test management engine may simulate an OK response by querying the state of the CDMA base station until obtaining a READY state.

At 7, the test management engine may send a request to the CDMA base station emulator to set a device IP address, a DNS IP address, and/or a NetMask. Thereafter (e.g., at 7.1), the CDMA base station emulator may send a response (e.g., OK) after updating settings to the specified values. At 8, a user may initialize a unit under test (UUT) (e.g., FLO user device, . . . ). At 9, the UUT may request the CDMA base station emulator for the IP address and the DNS IP address. At 10, the CDMA base station emulator may provide the IP address and the DNS IP address. At 11, the UUT may provide feedback to the user regarding the UUT being initialized. At 12, the user may instruct the test management console to start streaming the data stream corresponding to test case X. At 13, the test management console may relay the user command to start streaming the data corresponding to test case X to the test management engine. At 14, the test management engine may send a command to the CDMA base station emulator to set its time to T1. In response, the CDMA base station emulator may send a signal (e.g., OK) after setting its time to T1.

At 15, the test management engine may instruct the FLO network simulator to start streaming data for the test case X. At 16, the test management engine may inform the test management console that the streaming has started for test case X. At 17, the test management console may relay the information (e.g., pertaining to the start of streaming) to the user. Thereafter, the user may perform actions on the device in accordance with test case X. At 18, the FLO network simulator may start sending data for test case X to the exciter in ASI format. For example, the sending of data may be concurrently performed with the test management engine informing the test management console that streaming has started. At 19, the exciter may generate a FLO waveform for test case X, which may be sent to the WUT. At 20, the UUT and the FLO network simulator may exchange FLO signaling messages over the CDMA network (e.g., CDMA base station emulator). At 21, as the test is completed, the test management engine may instruct the FLO network simulator to stop streaming data. At 22, the user may submit results of the test case X. At 23, the results may be forwarded to the test management engine.

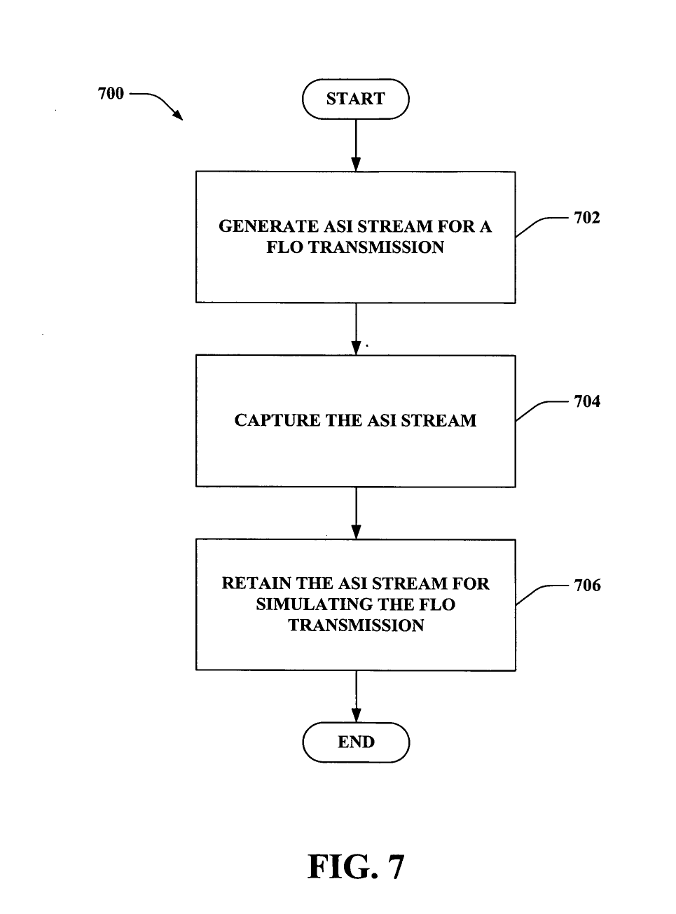

Referring to FIGS. 7-9, methodologies relating to simulating a FLO network to enable certifying, qualifying, etc. FLO user device(s) are illustrated. For example, methodologies can relate to certifying such devices in an FDMA environment, an OFDMA environment, a CDMA environment, a WCDMA environment, a TDMA environment, an SDMA environment, or any other suitable wireless environment. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Turning to FIG. 7, illustrated is a methodology 700 that facilitates intercepting and/or storing ASI stream(s) that may be utilized to simulate a FLO network. At 702, an ASI stream for a FLO transmission may be generated. For instance, any content (e.g., audio, video, IP datcast, . . . ) may be provided by content provider(s). Such content (e.g., from a content provider, a plurality of content providers, . . . ) may be multiplexed to yield the ASI stream. At 704, the ASI stream may be captured. By way of illustration, the ASI stream may be intercepted prior to transmission to a satellite via an uplink. Additionally or alternatively, the ASI stream may be obtained before an exciter converts the ASI stream into a radio frequency FLO waveform for transmission to any number of mobile devices. The ASI stream may encompass relevant information in a format that allows for representing the FLO network. According to an illustration, the ASI data may be compact and/or may be captured in real time. At 706, the ASI stream may be retained for simulating the FLO transmission. For instance, the ASI stream may be stored in memory. Moreover, the ASI stream may be utilized at a later time to simulate behavior of the FLO network.

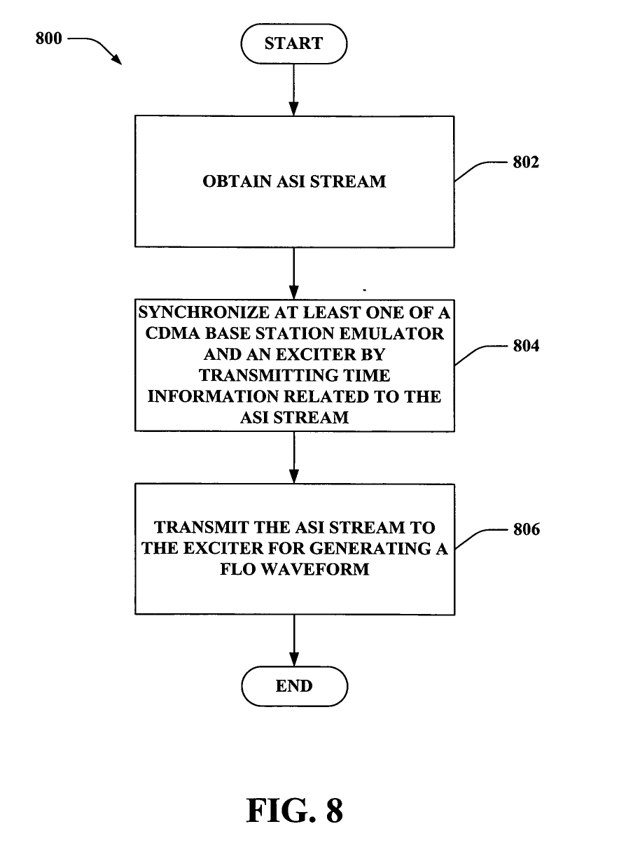

Referring to FIG. 8, illustrated is a methodology 800 that facilitates simulating a FLO network to enable testing FLO enabled mobile device(s). At 802, an ASI stream may be obtained. For instance, the ASI stream may be received from memory. At 804, at least one of a CDMA base station emulator and an exciter may be synchronized by transmitting time information related to the ASI stream. Thus, the obtained ASI stream may be analyzed to identify such encapsulated timing information. At 806, the ASI stream may be transmitted to the exciter for generating a FLO waveform. The FLO waveform may include, for instance, audio data, video data, clipcast data, IPDC data, any disparate data sent over FLO stream(s), programming guide data, system information, time information (e.g., FLO time), etc. Further, although not depicted, it is to be appreciated that FLO signaling may be received. For instance, the FLO signaling may occur from a FLO enabled mobile device being tested via a CDMA network (e.g., employing any 3G protocol such as EV-DO, 1x, . . . ). Moreover, such signaling may be over IP.

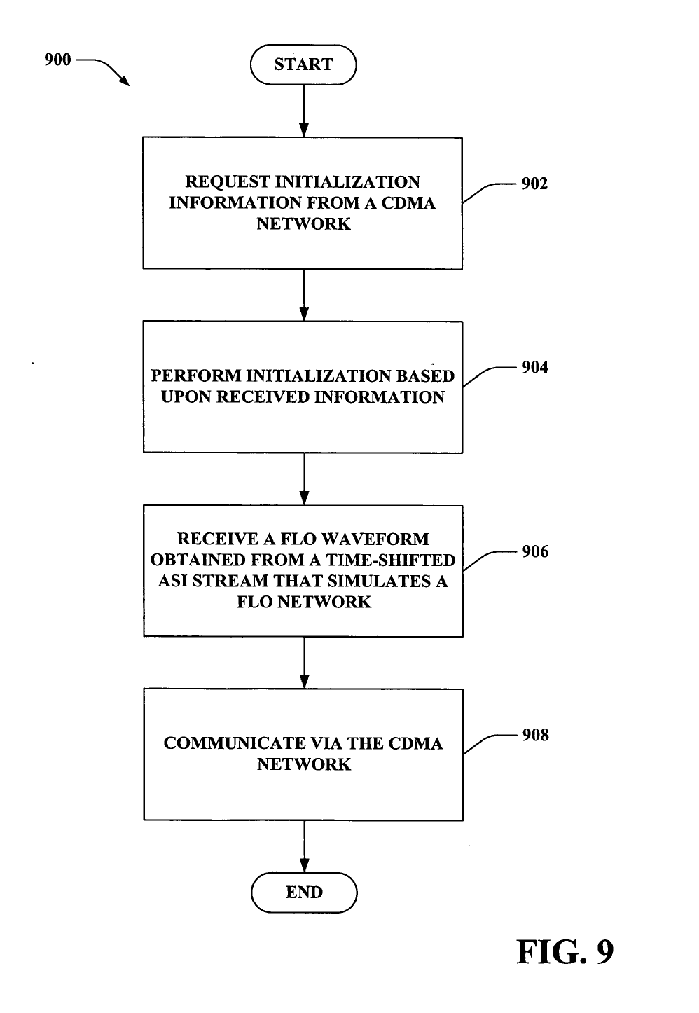

Now turning to FIG. 9, illustrated is a methodology 900 that facilitates testing a FLO user device and/or performing signaling over a CDMA network. At 902, initialization information may be requested from a CDMA network (e.g., CDMA base station emulator). The initialization information may relate to, for instance, an IP address, a DNS IP address, a NetMask, etc. At 904, initialization may be performed based upon the received information. At 906, a FLO waveform obtained from a time-shifted ASI stream that simulates a FLO network may be received. For example, the FLO waveform may be received from an exciter that may employ similar settings to a disparate exciter associated with a real system that generated the ASI stream (e.g., which may have been intercepted, . . . ). Pursuant to an example, data associated with the received FLO waveform may be outputted (e.g., via display(s), speaker(s), . . . ), analyzed, etc. At 908, communication may occur via the CDMA network. For example, signaling may be performed over the CDMA network.

It will be appreciated that, in accordance with one or more aspects described herein, inferences can be made simulating a FLO network, certifying a FLO user device, etc. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

According to an example, one or more methods presented above can include making inferences regarding determining whether FLO user device(s) are operating properly within a simulated FLO network. By way of further illustration, an inference may be made related to identifying network conditions of a real FLO network that may be utilized in connection with simulating the FLO network at a later time. It will be appreciated that the foregoing examples are illustrative in nature and are not intended to limit the number of inferences that can be made or the manner in which such inferences are made in conjunction with the various embodiments and/or methods described herein.

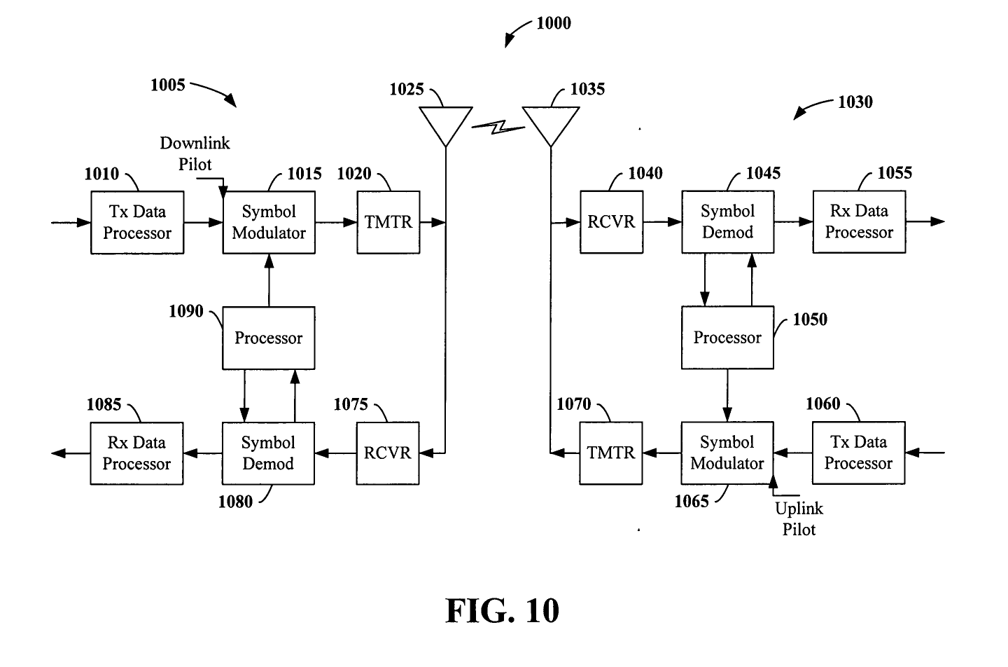

FIG. 10 shows an exemplary wireless communication system 1000. The wireless communication system 1000 depicts one access point (e.g., base station) and one terminal for sake of brevity. However, it is to be appreciated that the system can include more than one access point and/or more than one terminal, wherein additional access points and/or terminals can be substantially similar or different for the exemplary access point and terminal described below. In addition, it is to be appreciated that the access point and/or the terminal can employ the systems (FIGS. 1-5) and/or methods (FIGS. 7-9) described herein to facilitate wireless communication there between.

Referring now to FIG. 10, on a downlink, at access point 1005, a transmit (TX) data processor 1010 receives, formats, codes, interleaves, and modulates (or symbol maps) traffic data and provides modulation symbols (“data symbols”). A symbol modulator 1015 receives and processes the data symbols and pilot symbols and provides a stream of symbols. A symbol modulator 1015 multiplexes data and pilot symbols and provides them to a transmitter unit (TMTR) 1020. Each transmit symbol may be a data symbol, a pilot symbol, or a signal value of zero. The pilot symbols may be sent continuously in each symbol period. The pilot symbols can be frequency division multiplexed (FDM), orthogonal frequency division multiplexed (OFDM), time division multiplexed (TDM), frequency division multiplexed (FDM), or code division multiplexed (CDM).

TMTR 1020 receives and converts the stream of symbols into one or more analog signals and further conditions (e.g., amplifies, filters, and frequency upconverts) the analog signals to generate a downlink signal suitable for transmission over the wireless channel. The downlink signal is then transmitted through an antenna 1025 to the terminals. At terminal 1030, an antenna 1035 receives the downlink signal and provides a received signal to a receiver unit (RCVR) 1040. Receiver unit 1040 conditions (e.g., filters, amplifies, and frequency downconverts) the received signal and digitizes the conditioned signal to obtain samples. A symbol demodulator 1045 demodulates and provides received pilot symbols to a processor 1050 for channel estimation. Symbol demodulator 1045 further receives a frequency response estimate for the downlink from processor 1050, performs data demodulation on the received data symbols to obtain data symbol estimates (which are estimates of the transmitted data symbols), and provides the data symbol estimates to an RX data processor 1055, which demodulates (i.e., symbol demaps), deinterleaves, and decodes the data symbol estimates to recover the transmitted traffic data. The processing by symbol demodulator 1045 and RX data processor 1055 is complementary to the processing by symbol modulator 1015 and TX data processor 1010, respectively, at access point 1005.

On the uplink, a TX data processor 1060 processes traffic data and provides data symbols. A symbol modulator 1065 receives and multiplexes the data symbols with pilot symbols, performs modulation, and provides a stream of symbols. A transmitter unit 1070 then receives and processes the stream of symbols to generate an uplink signal, which is transmitted by the antenna 1035 to the access point 1005.

At access point 1005, the uplink signal from terminal 1030 is received by the antenna 1025 and processed by a receiver unit 1075 to obtain samples. A symbol demodulator 1080 then processes the samples and provides received pilot symbols and data symbol estimates for the uplink. An RX data processor 1085 processes the data symbol estimates to recover the traffic data transmitted by terminal 1030. A processor 1090 performs channel estimation for each active terminal transmitting on the uplink. Multiple terminals may transmit pilot concurrently on the uplink on their respective assigned sets of pilot subbands, where the pilot subband sets may be interlaced.

Processors 1090 and 1050 direct (e.g., control, coordinate, manage, etc.) operation at access point 1005 and terminal 1030, respectively. Respective processors 1090 and 1050 can be associated with memory units (not shown) that store program codes and data. Processors 1090 and 1050 can also perform computations to derive frequency and impulse response estimates for the uplink and downlink, respectively.

For a multiple-access system (e.g., FDMA, OFDMA, CDMA, TDMA, etc.), multiple terminals can transmit concurrently on the uplink. For such a system, the pilot subbands may be shared among different terminals. The channel estimation techniques may be used in cases where the pilot subbands for each terminal span the entire operating band (possibly except for the band edges). Such a pilot subband structure would be desirable to obtain frequency diversity for each terminal. The techniques described herein may be implemented by various means. For example, these techniques may be implemented in hardware, software, or a combination thereof. For a hardware implementation, the processing units used for channel estimation may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes may be stored in memory unit and executed by the processors 1090 and 1050.

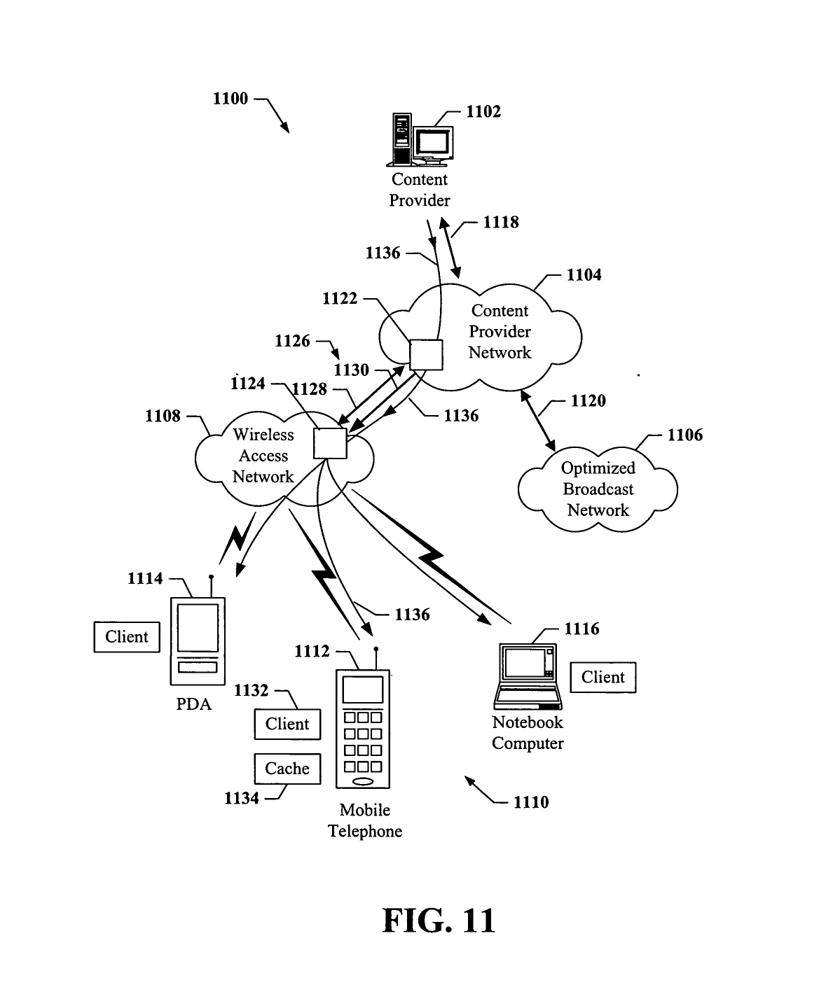

FIG. 11 shows an embodiment of a communication network 1100 that comprises an embodiment of a transport system that operates to create and transport multimedia content flows across data networks. For example, the transport system is suitable for use in transporting content clips from a content provider network to a wireless access network for broadcast distribution.

Network 1100 comprises a content provider (CP) 1102, a content provider network 1104, an optimized broadcast network 1106, and a wireless access network 1108. Network 1100 also includes devices 1110 that comprise a mobile telephone 1112, a personal digital assistance (PDA) 1114, and a notebook computer 1116. Devices 1110 illustrate just some of the devices that are suitable for use in one or more embodiments of the transport system. It should be noted that although three devices are shown in FIG. 11, virtually any number of devices, or types of devices are suitable for use in the transport system.

Content provider 1102 operates to provide content for distribution to users in network 1100. The content comprises video, audio, multimedia content, clips, real-time and non real-time content, scripts, programs, data or any other type of suitable content. Content provider 1102 provides the content to content provider network 1104 for distribution. For example, content provider 1102 communicates with content provider network 1104 via a communication link 1118, which comprises any suitable type of wired and/or wireless communication link.

Content provider network 1104 comprises any combination of wired and wireless networks that operate to distribute content for delivery to users. Content provider network 1104 communicates with optimized broadcast network 1106 via a link 1120. Link 1120 comprises any suitable type of wired and/or wireless communication link. Optimized broadcast network 1106 comprises any combination of wired and wireless networks that are designed to broadcast high quality content. For example, optimized broadcast network 1106 may be a specialized proprietary network that has been optimized to deliver high quality content to selected devices over a plurality of optimized communication channels.

In one or more embodiments, the transport system operates to deliver content from content provider 1102 for distribution to a content server (CS) 1122 at content provider network 1104 that operates to communicate with a broadcast base station (BBS) 1124 at wireless access network 1108. CS 1122 and BBS 1124 communicate using one or more embodiments of a transport interface 1126 that allows content provider network 1104 to deliver content in the form of content flows to wireless access network 1108 for broadcast/multicast to devices 1110. Transport interface 1126 comprises a control interface 1128 and a bearer channel 1130. Control interface 1128 operates to allow CS 1122 to add, change, cancel, or otherwise modify contents flows that flow from content provider network 1104 to wireless access network 1108. Bearer channel 1130 operates to transport the content flows from content provider network 1104 to wireless access network 1108.

In one or more embodiments, CS 1122 uses transport interface 1126 to schedule a content flow to be transmitted to BBS 1124 for broadcast/multicast over wireless access network 1108. For example, the content flow may comprise a non real-time content clip that was provided by content provider 1102 for distribution using content provider network 1104. In an embodiment, CS 1122 operates to negotiate with BBS 1124 to determine one or more parameters associated with the content clip. Once BBS 1124 receives the content clip, it broadcasts/multicasts the content clip over wireless access network 1108 for reception by one or more devices 1110. Any of devices 1110 may be authorized to receive the content clip and cache it for later viewing by the device user.

For example, device 1110 comprises a client program 1132 that operates to provide a program guide that displays a listing of content that is scheduled for broadcast over wireless access network 1108. The device user may then select to receive any particular content for rendering in real-time or to be stored in a cache 1134 for later viewing. For example the content clip may be scheduled for broadcast during the evening hours, and device 1112 operates to receive the broadcast and cache the content clip in cache 1134 so that the device user may view the clip the next day. Typically, the content is broadcast as part of a subscription service and the receiving device may need to provide a key or otherwise authenticate itself to receive the broadcast.

In one or more embodiments, the transport system allows CS 1122 to receive program-guide records, program contents, and other related information from content provider 1102. CS 1122 updates and/or creates content for delivery to devices 1110.

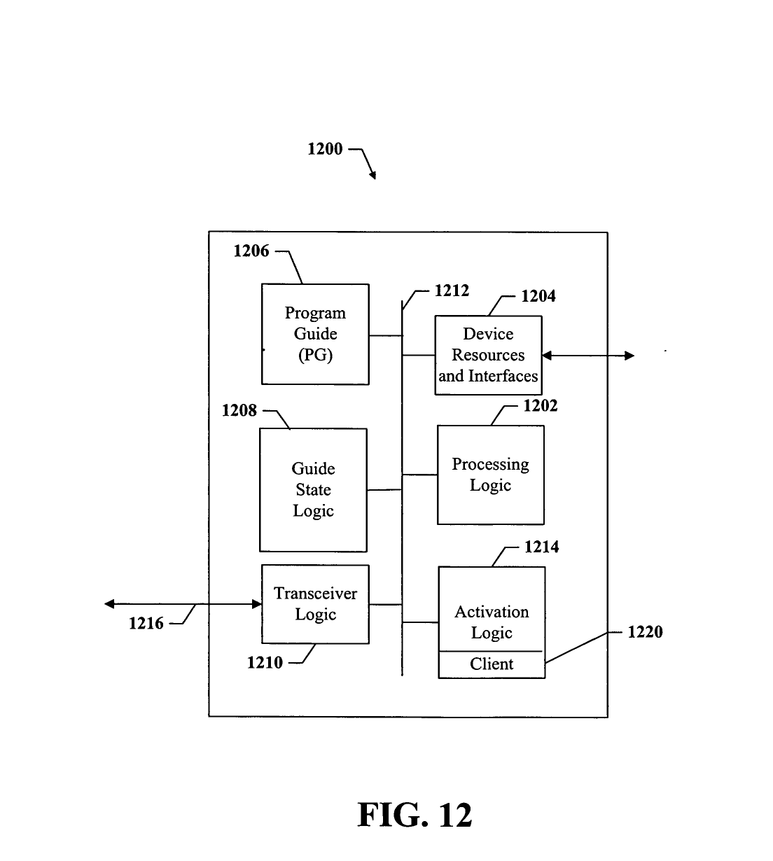

FIG. 12 shows an embodiment of a content provider server 1200 suitable for use in an embodiment of the content delivery system. For example, server 1200 may be used as the server 1102 in FIG. 11. Server 1200 comprises processing logic 1202, resources and interfaces 1204, and transceiver logic 1210, all coupled to an internal data bus 1212. Server 1200 also comprises activation logic 1214, program guide (PG) 1206, and PG records logic 1208, which are also coupled to data bus 1212.

In one or more embodiments, processing logic 1202 comprises a CPU, processor, gate array, hardware logic, memory elements, virtual machine, software, and/or any combination of hardware and software. Thus, processing logic 1202 generally comprises logic to execute machine-readable instructions and to control one or more other functional elements of server 1200 via internal data bus 1212.

The resources and interfaces 1204 comprise hardware and/or software that allow server 1200 to communicate with internal and external systems. For example, the internal systems may include mass storage systems, memory, display driver, modem, or other internal device resources. The external systems may include user interface devices, printers, disk drives, or other local devices or systems.

Transceiver logic 1210 comprises hardware logic and/or software that operates to allow server 1200 to transmit and receive data and/or other information with remote devices or systems using communication channel 1216. For example, in an embodiment, communication channel 1216 comprises any suitable type of communication link to allow server 1200 to communicate with a data network.

Activation logic 1214 comprises a CPU, processor, gate array, hardware logic, memory elements, virtual machine, software, and/or any combination of hardware and software. Activation logic 1214 operates to activate a CS and/or a device to allow the CS and/or the device to select and receive content and/or services described in PG 1206. In one or more embodiments, activation logic 1214 transmits a client program 1220 to the CS and/or the device during the activation process. Client program 1220 runs on the CS and/or the device to receive PG 1206 and display information about available content or services to the device user. Thus, activation logic 1214 operates to authenticate a CS and/or a device, download client 1220, and download PG 1206 for rendering on the device by client 1220.

PG 1206 comprises information in any suitable format that describes content and/or services that are available for devices to receive. For example, PG 1206 may be stored in a local memory of server 1200 and may comprise information such as content or service identifiers, scheduling information, pricing, and/or any other type of relevant information. In an embodiment, PG 1206 comprises one or more identifiable sections that are updated by processing logic 1202 as changes are made to the available content or services.

PG record 1208 comprises hardware and/or software that operates to generate notification messages that identify and/or describe changes to PG 1206. For example, when processing logic 1202 updates PG 1206, PG records logic 1208 is notified about the changes. PG records logic 1208 then generates one or more notification messages that are transmitted to CSs, which may have been activated with server 1200, so that these CSs are promptly notified about the changes to PG 1206.

In an embodiment, as part of the content delivery notification message, a broadcast indicator is provided that indicates when a section of PG 1206 identified in the message will be broadcast. For example, in one embodiment, the broadcast indicator comprises one bit to indicate that the section will be broadcast and a time indicator that indicates when the broadcast will occur. Thus, the CSs and/or the devices wishing to update their local copy of the PG records can listen for the broadcast at the designated time to receive the updated section of the PG records.

In an embodiment, the content delivery notification system comprises program instructions stored on a computer-readable media, which when executed by a processor, for instance, processing logic 1202, provides the functions of server 1200 described herein. For example, the program instructions may be loaded into server 1200 from a computer-readable media, such as a floppy disk, CDROM, memory card, FLASH memory device, RAM, ROM, or any other type of memory device or computer-readable media that interfaces to server 1200 through resources 1204. In another embodiment, the instructions may be downloaded into server 1200 from an external device or network resource that interfaces to server 1200 through transceiver logic 1210. The program instructions, when executed by processing logic 1202, provide one or more embodiments of a guide state notification system as described herein.

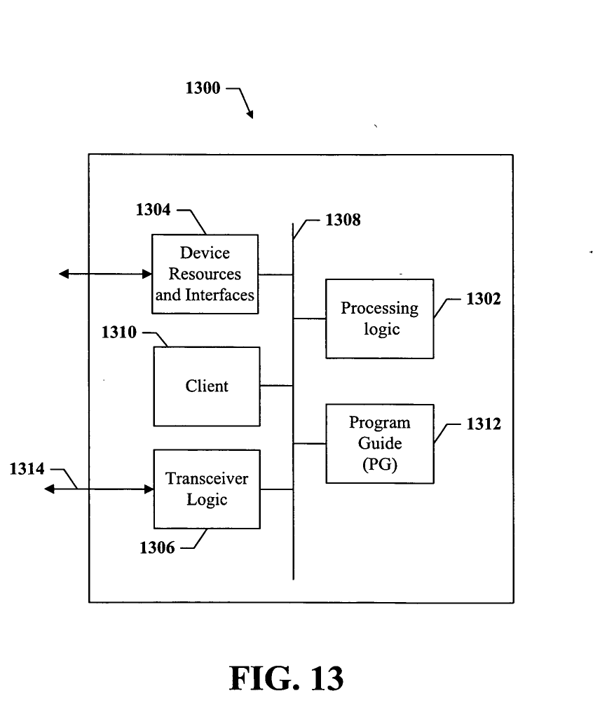

FIG. 13 shows an embodiment of a content server (CS) or device 1300 suitable for use in one or more embodiments of a content delivery system. For example, CS 1300 may be CS 1122 or device 1110 shown in FIG. 11. CS 1300 comprises processing logic 1302, resources and interfaces 1304, and transceiver logic 1306, all coupled to a data bus 1308. CS 1300 also comprises a client 1310, a program logic 1314 and a PG logic 1312, which are also coupled to data bus 1308.

In one or more embodiments, processing logic 1302 comprises a CPU, processor, gate array, hardware logic, memory elements, virtual machine, software, and/or any combination of hardware and software. Thus, processing logic 1302 generally comprises logic configured to execute machine-readable instructions and to control one or more other functional elements of CS 1300 via internal data bus 1308.

The resources and interfaces 1304 comprise hardware and/or software that allow CS 1300 to communicate with internal and external systems. For example, internal systems may include mass storage systems, memory, display driver, modem, or other internal device resources. The external systems may include user interface devices, printers, disk drives, or other local devices or systems.

Transceiver logic 1306 comprises hardware and/or software that operate to allow CS 1300 to transmit and receive data and/or other information with external devices or systems through communication channel 1314. For example, communication channel 1314 may comprise a network communication link, a wireless communication link, or any other type of communication link.

During operation, CS and/or device 1300 is activated so that it may receive available content or services over a data network. For example, in one or more embodiments, CS and/or device 1300 identifies itself to a content provider server during an activation process. As part of the activation process, CS and/or device 1300 receives and stores PG records by PG logic 1312. PG 1312 contains information that identifies content or services available for CS 1300 to receive. Client 1310 operates to render information in PG logic 1312 on CS and/or device 1300 using the resources and interfaces 1304. For example, client 1310 renders information in PG logic 1312 on a display screen that is part of the device. Client 1310 also receives user input through the resources and interfaces so that a device user may select content or services.

In an embodiment, CS 1300 receives notification messages through transceiver logic 1306. For example, the messages may be broadcast or unicast to CS 1300 and received by transceiver logic 1306. The PG notification messages identify updates to the PG records at PG logic 1312. In an embodiment, client 1310 processes the PG notification messages to determine whether the local copy at PG logic 1312 needs to be updated. For example, in one or more embodiments, the notification messages include a section identifier, start time, end time, and version number. CS 1300 operates to compare the information in the PG notification messages to locally stored information at the existing PG logic 1312. If CS 1300 determines from the PG notification messages that one or more sections of the local copy at PG logic 1312 needs to be updated, CS 1300 operates to receive the updated sections of the PG in one of several ways. For example, the updated sections of the PG may be broadcasted at a time indicated in the PG notification messages, so that transceiver logic 1306 may receive the broadcasts and pass the updated sections to CS 1300, which in turn updates the local copy at PG logic 1312.

In other embodiments, CS 1300 determines which sections of the PG need to be updated based on the received PG update notification messages, and transmits a request to a CP server to obtain the desired updated sections of the PG. For example, the request may be formatted using any suitable format and comprise information such as a requesting CS identifier, section identifier, version number, and/or any other suitable information.

In one or more embodiments, CS 1300 performs one or more of the following functions in one or more embodiments of a PG notification system. It should be noted that the following functions might be changed, rearranged, modified, added to, deleted, or otherwise adjusted within the scope of the embodiments.
1. The CS is activated for operation with a content provider system to receive content or services. As part of the activation process, a client and PG are transmitted to the CS.
2. One or more PG notification messages are received by the CS and used to determine if one or more sections of the locally stored PG need to be updated.
3. In an embodiment, if the CS determines that one or more sections of the locally stored PG need to be updated, the CS listens to a broadcast from the distribution system to obtain the updated sections of the PG that it needs to update its local copy.
4. In other embodiments, the CS transmits one or more request messages to the CP to obtain the updated sections of the PG it needs.
5. In response to the request, the CP transmits the updated sections of the PG to the CS.
6. The CS uses the received updated sections of the PG to update its local copy of the PG.

In one or more embodiments, the content delivery system comprises program instructions stored on a computer-readable media, which when executed by a processor, such as processing logic 1302, provides the functions of the content delivery notification system as described herein. For example, instructions may be loaded into CS 1300 from a computer-readable media, such as a floppy disk, CDROM, memory card, FLASH memory device, RAM, ROM, or any other type of memory device or computer-readable media that interfaces to CS 1300 through the resources and interfaces 1304. In other embodiments, the instructions may be downloaded into CS 1300 from a network resource that interfaces to CS 1300 through transceiver logic 1306. The instructions, when executed by processing logic 1302, provide one or more embodiments of a content delivery system as described herein.

It should be noted that CS 1300 represents just one implementation and that other implementations are possible within the scope of the embodiments.

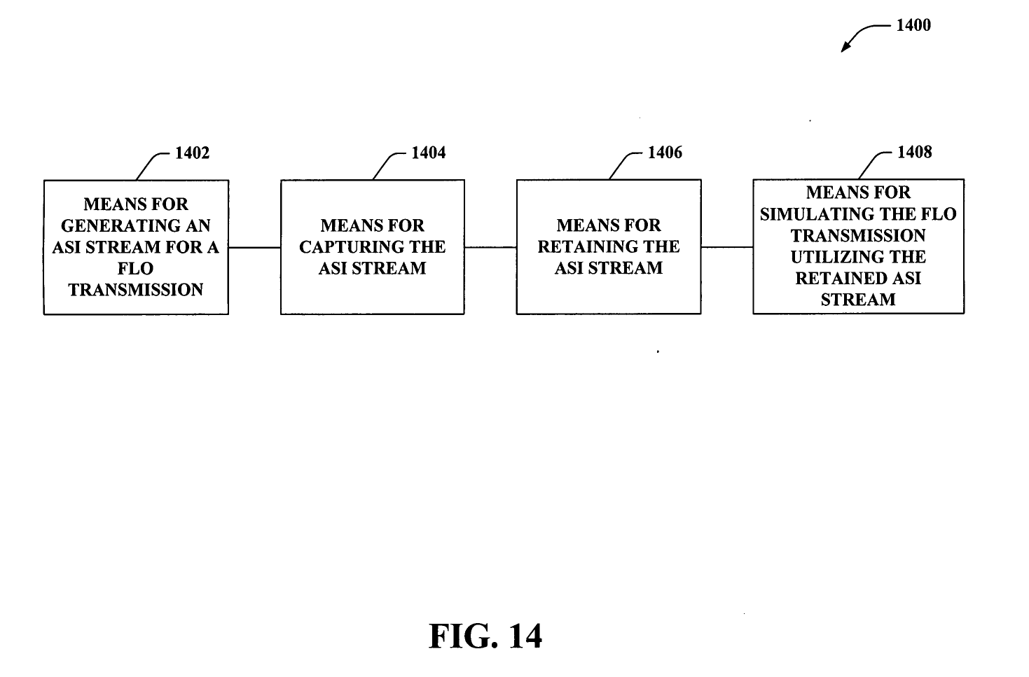

With reference to FIG. 14, illustrated is a system 1400 that simulates a FLO network for utilization in connection with certifying FLO enabled devices. It is to be appreciated that system 1400 is represented as including functional blocks, which can be functional blocks that represent functions implemented by a processor, software, or combination thereof (e.g., firmware). System 1400 can include means for generating an ASI stream for a FLO transmission 1402. Further, system 1400 may comprise means for capturing the ASI stream 1404. For example, the ASI stream may be intercepted prior to uplink transmission to a satellite. Moreover, system 1400 may include means for retaining the ASI stream 1406. System 1400 may also comprise means for simulating the FLO transmission utilizing the retained ASI stream 1408.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor via various means as is known in the art.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method that facilitates simulating a Forward Link Only (FLO) network for enabling device certification, comprising:
capturing an asynchronous serial interface (ASI) stream generated for a FLO transmission; and
retaining the ASI stream for simulating the FLO transmission.

2. The method of claim 1, capturing the ASI stream prior to uplink transmission to a satellite.

3. The method of claim 1, capturing the ASI stream before conversion into a radio frequency FLO waveform.

4. The method of claim 1, retaining the ASI stream in memory.

5. The method of claim 1, further comprising utilizing the ASI stream at a later time to simulate behavior of the FLO network.

6. The method of claim 1, further comprising synchronizing a CDMA base station emulator based upon timing information from the ASI stream.

7. The method of claim 1, further comprising synchronizing an exciter based upon timing information from the ASI stream.

8. The method of claim 1, further comprising analyzing the ASI stream to identify timing information.

9. The method of claim 1, further comprising transmitting the ASI stream to an exciter for generating a FLO waveform.

10. The method of claim 9, further comprising providing the FLO waveform to a FLO mobile device being tested.

11. The method of claim 1, receiving signaling information from a FLO mobile device via a CDMA network.

12. The method of claim 11, wherein the CDMA network employs a 3G protocol.

13. The method of claim 1, wherein the ASI stream enables simulating at least one of activation, digital rights management conditional access service, subscriptions, provisioning, signaling, overhead, programming guides, channel data, content ratings, and notifications.

14. The method of claim 1, wherein a notion of time for simulating the FLO transmission is fixed to a point in time that the ASI stream was generated.

15. The method of claim 1, wherein the ASI stream includes one or more of a control stream, an overhead stream, a video stream, and an audio stream.

16. The method of claim 1, wherein the ASI stream is played back through an exciter to recreate network conditions.

17. The method of claim 1, at least one of capturing and retaining the ASI stream in real time.

18. The method of claim 1, wherein the ASI stream simulates at least one of a service layer and an application layer associated with the FLO transmission.

19. A wireless communications apparatus, comprising:
a memory that retains a captured asynchronous serial interface (ASI) stream; and
a processor that evaluates the ASI stream to identify time information, synchronizes at least one of a CDMA network and an exciter based upon the time information, and transmits the ASI stream to the exciter to simulate a Forward Link Only (FLO) network.

20. The wireless communications apparatus of claim 19, wherein the processor effectuates signaling via the CDMA network over IP.

21. The wireless communications apparatus of claim 19, wherein the processor utilizes configuration files associated with the ASI stream to simulate the FLO network.

22. The wireless communications apparatus of claim 19, wherein the processor at least one of starts and stops transmission of the ASI stream.

23. The wireless communications apparatus of claim 19, wherein the processor transmits the ASI stream relevant to a particular test.

24. The wireless communications apparatus of claim 19, wherein the processor simulates real conditions associated with a transmission channel.

25. The wireless communications apparatus of claim 19, wherein the processor intercepts and stores the ASI stream in the memory after multiplexing.

26. A wireless communications apparatus that simulates a Forward Link Only (FLO) network for utilization in connection with certifying FLO enabled devices, comprising:
means for generating an asynchronous serial interface (ASI) stream for a FLO transmission;
means for capturing the ASI stream;
means for retaining the ASI stream; and
means for simulating the FLO transmission utilizing the retained ASI stream.

27. The wireless communications apparatus of claim 26, further comprising means for generating a FLO waveform from the ASI stream.

28. The wireless communications apparatus of claim 26, further comprising means for communicating over a CDMA network.

29. The wireless communications apparatus of claim 26, further comprising means for synchronizing the FLO network with a CDMA network.

30. The wireless communications apparatus of claim 26, further comprising means for identifying a particular ASI stream from a set of retained ASI streams to transmit based upon a test of a device to be performed.

31. The wireless communications apparatus of claim 26, further comprising means for simulating at least one of a service layer and an application layer associated with the FLO network.

32. A machine-readable medium having stored thereon machine-executable instructions for:
requesting initialization information from a CDMA network;
initializing a Forward Link Only (FLO) device being tested based upon the initialization information;
receiving a FLO waveform obtained from a time-shifted asynchronous serial interface (ASI) stream that simulates a FLO network; and
communicating via the CDMA network

33. The machine-readable medium of claim 32, the machine-executable instructions further comprise receiving the initialization information that includes at least one of an IP address, a DNS IP address, and a NetMask.

34. The machine-readable medium of claim 32, the machine-executable instructions further comprise receiving the FLO waveform from an exciter that employs settings similar to a disparate exciter associated with a system that generated the ASI stream.

35. The machine-readable medium of claim 32, the machine-executable instructions further comprise analyzing the received FLO waveform to test the FLO device.

36. The machine-readable medium of claim 32, the machine-executable instructions further comprise outputting the received FLO waveform with the FLO device.

37. The machine-readable medium of claim 32, wherein the FLO waveform simulates at least one of activation, digital rights management conditional access service, subscriptions, provisioning, signaling, overhead, programming guides, channel data, content ratings, and notifications.

38. The machine-readable medium of claim 32, wherein the ASI stream is stored in a compact form.

39. The machine-readable medium of claim 32, wherein the FLO network and the CDMA network employ corresponding times within a predetermined range.

40. A processor that executes the following instructions:
capturing an asynchronous serial interface (ASI) stream;
storing the ASI stream; and
transmitting the ASI stream to an exciter for generating a radio frequency signal that simulates a Forward Link Only (FLO) transmission for testing a FLO enabled device.
